(19) United States
(12) Patent Application Publication
(10) Pub. No.: US 2005/0146638 A1
(43) Pub. Date: Jul. 7, 2005

(54) Image pickup device adapting its aperture shape to pixel shape of imaging sensor

(75) Inventor: Shinji Takeuchi, Saitama-shi (JP)

Correspondence Address: SNIDER & ASSOCIATES, P. O. BOX 27613, WASHINGTON, DC, 20038-7613, US

(73) Assignee: Fujinon Corporation, Saitama-shi (JP)

(21) Appl. No.: 11/022,693

(22) Filed: Dec. 28, 2004

(30) Foreign Application Priority Data
Jan. 5, 2004 (JP) 2004-299

(51) Int. Cl. H04N 5/235

(52) U.S. Cl. 348/363; 348/362

(57) ABSTRACT

In an electronic endoscope to image a light illumined observed object by a CCD, openings R₁ to R₃ Of fixed apertures set in a scope are shaped approximately similar to the pixel shape of the CCD. For example, in case the pixel is rectangular, a rectangular opening R₁ similar to this pixel is set. Further, this aperture may be set with openings E₁ to E₃ with its angle portion arc-shaped, and an oval opening E₁ is set for the rectangular pixel. According to this approach, since the confused rectangular shape of the aperture opening matches the pixel shape, a light flux can be allowed to effectively enter from the aperture, thereby increasing the light quantity of a pixel unit. Further, a MTF characteristic in this case does not change with no lowering of the resolution caused.

### BACKGROUND OF THE INVENTION

The application claims the priority of Japanese Patent Applications No. 2004-299 filed on Jan. 5, 2004 which is incorporated herein by reference.

### FIELD OF THE INVENTION

The present invention relates to an image pickup device, and in particular, it relates to an aperture stop of an image pickup device mounted with an imaging sensor in which rectangular pixels are set.

### DESCRIPTION OF THE RELATED ART

Heretofore, in general, an image pickup device such as an electronic endoscope, a compact camera, a digital camera, a video camera, and the like has performed the imaging of an observed object and an object by a solid state imaging sensor such as CCD (Charge Coupled Device) and the like. For example, the electronic endoscope is provided with an objective optical system having an aperture stop (fixed aperture) and a CCD at its top end portion, and by illumination of a light source light guided by a light guide, the observed object is imaged by the CCD through the objective optical system. By subjecting imaging signals outputted from this CCD to various signal processings by a processor device and the like, the observed object can be observed on a monitor screen.

In FIG. 6 is shown a pixel shape set in a conventional CCD, and in this CCD 1, as shown in FIG. 6(B), a pixel 2 is set, which is longitudinally rectangular instead of having a length to width ratio of 1:1 to enhance the resolution of an image (projected image). That is, to enhance the resolution of the image, the number of pixels of the CCD 1 of FIG. 6(A) is required to be high. However, since the projected image imaged by this CCD 1 is often observed by a monitor, the number of pixels in a vertical direction is limited by the number of vertical scan lines for monitor display, and even when the number of vertical pixels is increased, a vertical resolution is not enhanced. Hence, the shape of the pixel 2 is changed to a longitudinally rectangular shape (width is shortened) which has a length to width ratio of [not less than 1:1], thereby increasing the number of pixels in a horizontal direction (high pixel density) and enhancing a horizontal resolution. There exists some CCD in which the pixel is set so as to be a horizontally rectangular shape.

### SUMMARY OF THE INVENTION

Now, in recent years, due to urging wishes for the small diameter in an electronic endoscope, and urging wishes for the miniaturization in other image pickup devices also, the miniaturization of a CCD has been started, and moreover, to enhance the resolution of an image (projected image), as described above, incorporation of a high number of pixels of the CCD has been promoted, and therefore, a light quantity and brightness obtained in an pixel unit have been apt to come down. Hence, in the conventional electronic endoscope, a xenon lamp having a high light-intensity or the like has been often used as a light source, but, in consideration of an influence over a human body which is an observed object, there is a limit to the light intensity which is illumined.

In the meantime, to improve the brightness which is in short supply in the image, a method of amplifying and processing signals obtained by the CCD is adopted, but, according to this method of signal amplification, there is a problem that an image quality deteriorates because of a lowering of S/N ratio.

The present invention has been made in view of the above described problems, and an object of the invention is to provide an image pickup device capable of increasing a light quantity and brightness to be obtained in a pixel unit and promoting the miniaturization and high quality image of an imaging sensor without lowering the S/N ratio and the resolution.

To achieve the above described object, the image pickup device according to the present invention includes an imaging sensor provided with pixels constituting the image, and an aperture portion which is provided for narrowing down a light flux incident on this imaging sensor and in which an aperture opening is shaped approximately similar to the pixel shape of the imaging sensor. As for the pixel shape of this imaging sensor, there are a longitudinally rectangular shape, a hook-shape, and the like.

Further, an image pickup device according to other inventions includes an imaging sensor provided with pixels constituting an image, and an aperture portion which is provided for narrowing down a light flux incident on this imaging sensor and in which an aperture opening is shaped approximately similar to the pixel shape of the imaging sensor, and moreover, in which the angle portion is circular-arc shaped. Here, in case the pixel shape of the imaging sensor is longitudinally rectangular, an opening of the aperture is made oval with a length to width ratio thereof made approximately the same as the rectangular shape.

According to the above described constitution, in case the pixel shape of the imaging sensor is rectangular, the opening shape of the aperture is similarly rectangular, and in case it is hook-shaped, the opening shape of the aperture is also similarly hook-shaped. As a result, a confused shape (an image shape of a point light source equivalent to a circle of confusion) of the aperture opening matches the pixel shape, and the maximum quantity of a light (light flux) incident from the aperture can be allowed to enter in a pixel unit. That is, the opening of the aperture generally used in the conventional image pickup device is circular, and in the case of this circular opening, as shown in FIG. 6(B), a circle of confusion 4 becomes smaller than the pixel 2 having a rectangular shape, and therefore, the light from the circular opening cannot be allowed adequately to enter the pixel areas. The present invention makes this circle of confusion 4 matched to the pixel shape so as to be confused rectangular, thereby increasing a light quantity (light flux passing through the opening in a pixel unit) incident on the pixel without enhancing a luminous light.

Further, the shape of the aperture opening approximately similar to the pixel shape as described above may be circular-arc shaped in its angle portion, and for example, in case the pixel is rectangular, the shape of the aperture opening may be made oval with a length to width ratio thereof made approximately the same as the rectangular shape. In both of these cases, similarly as described above, the light quantity incident on the pixel is increased.

According to the image pickup device according to the present invention, by making the aperture opening approximately similar to the pixel shape of the imaging sensor or circular-arc shaped in its angle portion, the light quantity and brightness obtained in a pixel unit can be increased without lowering the resolution, and moreover, the lowering of the S/N ratio can be prevented by avoidance of brightness adjustment by a signal amplifying processing, thereby the miniaturization and high image quality of the imaging sensor can be promoted.

### BRIEF DESCRIPTION OF THE DRAWINGS

FIG. 1 is a view showing the constitution of an electronic endoscope as an image pickup device according to the embodiment of the present invention;

FIG. 2(A) is a view of a CCD imaging region of an embodiment, and FIGS. 2(B) to (D) are views of an pixel shape set by the CCD;

FIG. 3(A) is a view of an aperture having a rectangular opening in the embodiment, FIG. 3(B) is a view of an aperture having a hook-shaped opening, and FIG. 3(C) is a view of an aperture having a step-shaped opening;

FIGS. 4(A) to 4(C) are graphical representations showing PSF (point spread function) in the aperture of a rectangular opening of the embodiment and the aperture of a conventional circular opening;

FIG. 5 is a view showing the shape of a rectangular pixel and a micro lens in case of providing the micro lens in the embodiment; and

FIG. 6(A) is a view of a pixel shape set by a conventional CCD, and FIG. 6(B) is a view showing a circle of confusion by a circular opening.

### DETAILED DESCRIPTION OF THE PREFERRED EMBODIMENTS

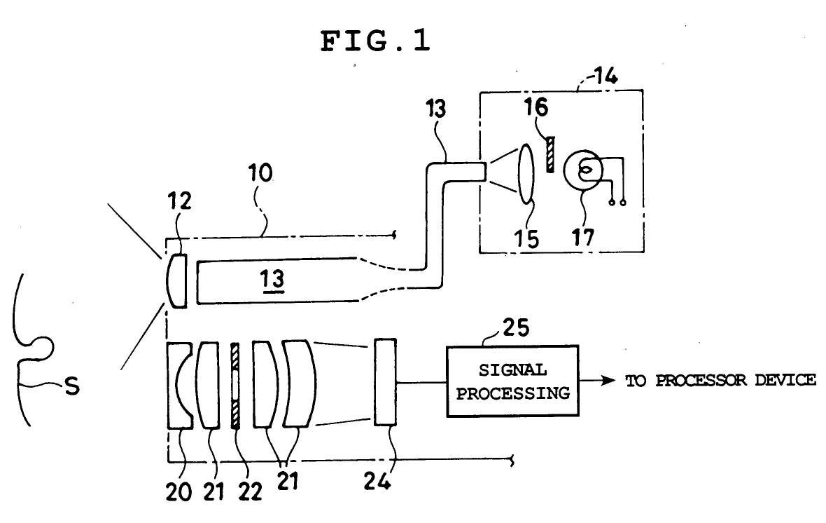

In FIG. 1 is shown a constitution of an electronic endoscope as an image pickup device according to an embodiment, and this electronic endoscope is provided with an illumination lens 12 and a light guide 13 at a top end portion of a scope 10. This light guide 13 is connected to a light source unit 14, and within this light source unit 14, there are provided a condensing lens 15, a variable aperture 16, and a light source 17. The light of this light source 17 is irradiated on an observed object S from a scope top end portion through the light guide 13. In the mean time, in the top end portion of the scope 10, there are provided an observation lens 20 as an objective optical system, and a lens group 21 including a movable lens for magnification and the like, and within this lens group 21, there are disposed fixed apertures 22 (A to C) to be described later.

Behind this objective optical system (20 to 22), there is provided a CCD 24 which is a solid state imaging sensor, and an imaging surface of this CCD 24 is disposed at the position where an image is formed by the objective optical system including the fixed aperture 22. This CCD 24 storage-controls a charge of a pixel unit, and is connected to a signal processor circuit 25 for processing various screen images by taking an outputted charge-storage signal as an image signal (screen image), and the output of this signal processor circuit 25 is supplied to a processor device.

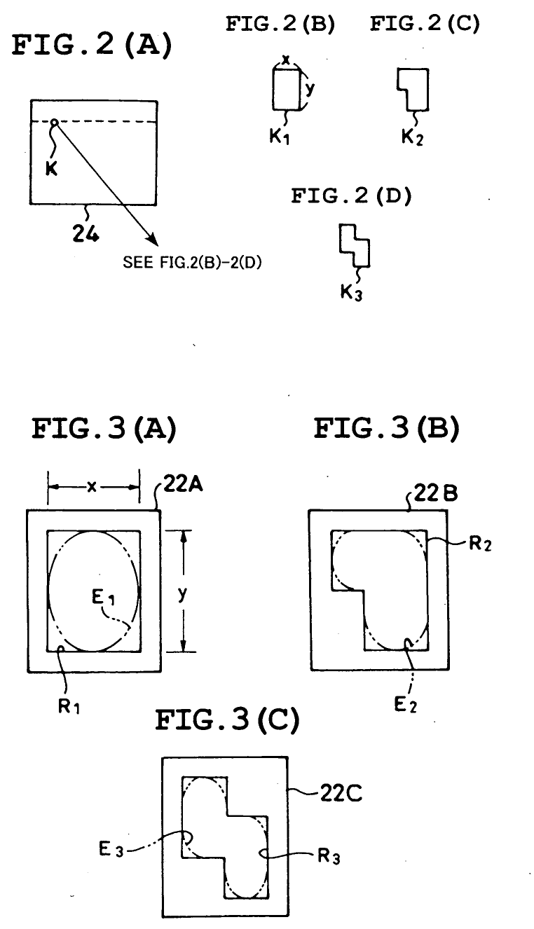

In FIG. 2 is shown an example of the pixel shape set by the CCD 24, and in the CCD 24 shown in FIG. 2(A), pixels K having shapes corresponding to the different number of pixels are set. Although the shape of this pixel K is generally, as shown in FIG. 2(B), a rectangular (orthogonal) pixel K₁, it is possible to set a hook-shaped (L-character) pixel K₂ such as FIG. 2(C), a step-shaped pixel K₃ such as FIG. 2(D), and a polygonal pixel.

In FIG. 3 is shown an opening shape provided for the aperture 22. FIG. 3(A) corresponds to the pixel K₁ of FIG. 2(B), and the aperture (fixed aperture) 22A is provided with a rectangular aperture R₁ which becomes similar to the shape having the same ratio of height (y) and width (x) as the rectangular shape of the pixel K₁. FIG. 3(B) corresponds to the pixel K₂ of FIG. 2(C), and the aperture 22B is provided with a hook-shaped opening R₂ which becomes the similar shape as the hook-shape of the pixel K₂, and FIG. 3(C) corresponds to the step-shaped pixel K₃ of FIG. 2(D), and the aperture 22C is provided with an opening R₃ which becomes the similar shape as the pixel K₃.

According to the objective optical system having the apertures 22A to 22C of such similar shaped openings R_{1 to R}₃, the confused shapes (equivalent to the circle of confusion) of the openings R₁ to R₃ in the image forming surface (imaging surface) on the CCD 24 match the shapes of the pixels K₁ to K₃. That is, in the case of the aperture 22A having the rectangular opening R₁, its confused rectangular shape matches (superposes on) the rectangular shape of the pixel K₁, and in the case of the aperture 22B having the hook-shaped opening R₂, its confused hooked shape matches the hooked shape of the pixel K₂, and also in the case of the aperture 22C, its confused shape matches the shape of the pixel K₃. Consequently, according to these similar openings R₁ to R₃, when compared with the conventional circular openings of FIG. 6(B), an image forming light can be allowed to effectively enter the regions of the pixels K₁ to K₃, and the light quantity (brightness) of a pixel unit can be increased without intensifying the illumination light. For example, in case a length to width ratio of the opening R₁ is 1.16:1, compared with the circular opening, an increase of the light quantity of approximately 20% can be achieved.

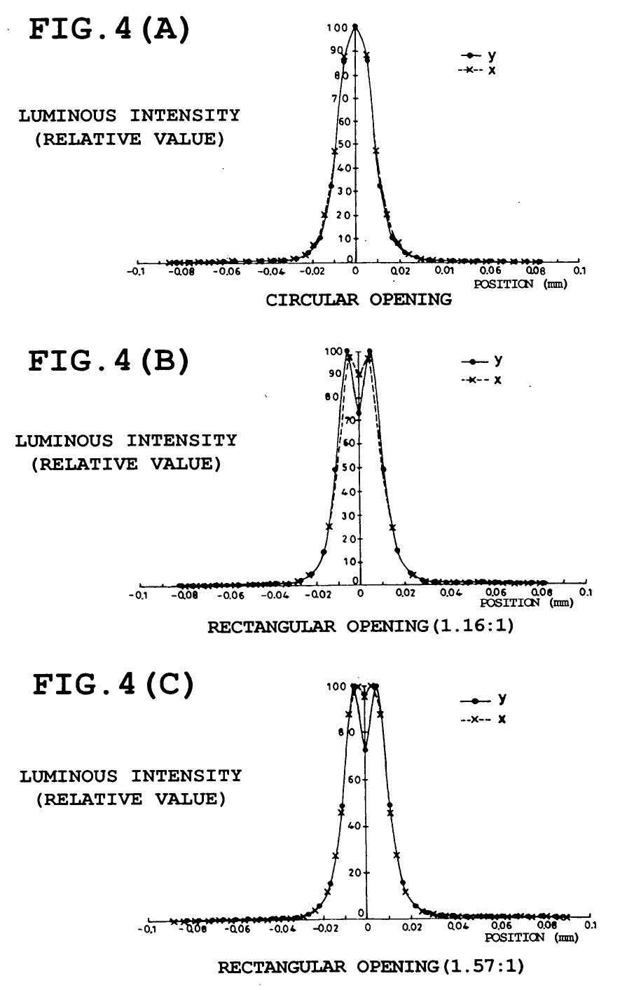

In FIG. 4 is shown a PSF (Point Spread Function) to estimate image resolutions in the circular opening and the rectangular opening. FIG. 4(A) is a graph of the conventional circular opening, FIG. 4(B) is a graph of the rectangular opening having a length to width ratio of 1.16:1, and FIG. 4(C) is a graph of the rectangular opening having a length to width ratio of 1.57:1. These graphs are obtained from the output of the CCD 24. As shown in these graphs, also in the case of the rectangular openings of FIGS. 4(B) and 4(C), a solid line showing a length direction (y) and a solid line showing a width direction (x) almost lie one upon another, and moreover, an extensity from the upper part of a curved line to its base is also almost the same as the case of the circular opening of FIG. 4(A), and the MTF (Modulation Transfer Function) characteristics thereof come to match. That is, in case of using the aperture of the circular opening having a length to width ratio of 1:1 is used for the conventional longitudinally rectangular pixel 2 as shown in FIG. 6, in the MTF characteristic, there is more allowance in a length (vertical) direction than in a width (horizontal) direction, and even in the case of the longitudinally rectangular opening R₁ similarly to the embodiment, the MTF characteristic does not change with no damage caused to the resolution.

Further, the openings of the apertures 22A to 22C may be circular-shaped (circular-arc shaped) in the angle portions. That is, as shown in FIG. 3(A), in the case of the aperture 22A, an oval opening E₁ in which a length (y) to width (x) ratio is the same as the rectangular pixel K₁ is set, and as shown in FIGS. 3(B) and 3(C), in the case of the apertures 22B and 22C, openings E₂ and E₃ which make the angle portion of an angle within 180 degrees into a circular-arc shape can be set. Even by so doing, an image forming light through the openings E₁ to E₃ can be allowed to effectively enter the pixel regions K₁ to K₃, thereby increasing the light quantity of a pixel unit much more than before.

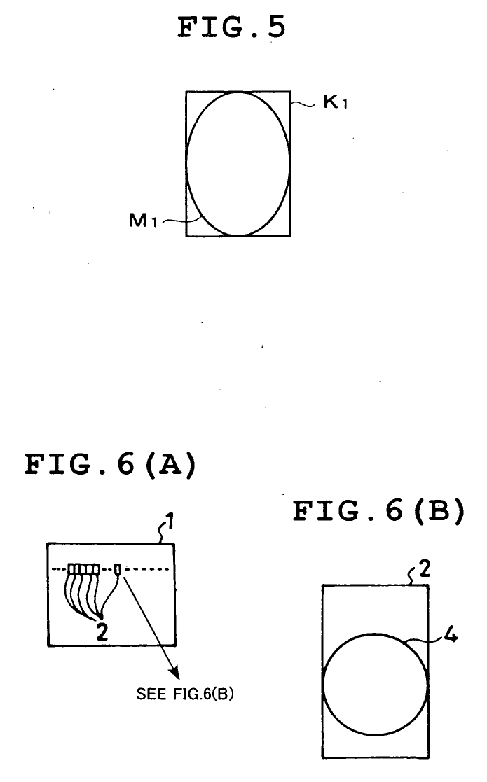

Further, in the case of the imaging sensor such as the CCD and the like, there are sometimes the cases where a micro lens (on chip lens) is provided on its upper surface side in a pixel unit, and when a shape of this micro lens and a pixel shape are different, an aperture shape is preferably set in consideration of the shape of this micro lens. For example, as shown in FIG. 5, when an oval micro lens M₁ is formed for the rectangular pixel K₁, the opening of the aperture 22A is set to a shape approximately similar to the oval shape of the micro lens M₁ (becomes the same as the opening E₁ of FIG. 3).

In the above described embodiment, though an example using the fixed apertures 22A to 22C as the aperture stops is shown, the present invention can be also applied to a variable aperture, and as for this variable aperture, for example, in the apertures 22A to 22C of FIG. 3, a plurality of aperture stops similar to the apertures R_{1 to R}₃ and E₁ to E₃ are prepared, and by selectively taking in and out these apertures, the aperture may be changed. Alternately, the apertures 22A to 22C are divided into two in a diagonal direction, and the aperture may be changed by moving these two aperture members in a diagonal direction.

Further, though the embodiment has been described by the electronic endoscope, it can be similarly applied to others such as a compact camera, a digital camera, a video camera and the like.

1. An image pickup device, including:
an imaging sensor provided with pixels constituting an image; and
an aperture portion which is provided for converging a light flux incident on this imaging sensor and which makes the shape of an aperture opening approximately similar to a pixel shape of the imaging sensor.

2. The image pickup device according to claim 1, wherein, in case the pixel shape of said imaging sensor is longitudinally rectangular, said aperture opening is made similarly rectangular.

3. The image pickup device according to claim 1, wherein, in case the pixel shape of said imaging sensor is hook-shaped, said aperture opening is made similarly hook-shaped.

4. An image pickup device, including:
an imaging sensor provided with pixels constituting an image; and
an aperture portion which is provided for converging a light flux incident on this imaging sensor, and which makes an aperture opening similar to the pixel shape of said imaging sensor and moreover, which makes its angle portion circular-arc.

5. The image pickup device according to claim 4, wherein, in case the pixel shape of said imaging sensor is longitudinally rectangular, the opening of said aperture is made oval with a length to width ratio thereof made approximately the same as the rectangular shape.

6. An image pickup device comprising an imaging sensor provided with pixels constituting an image and an aperture for converging a light flux incident on this imaging sensor,
wherein said aperture opening is shaped approximately similar to the pixel shape of said imaging pickup device.
